(19) United States
(12) Patent Application Publication
(10) Pub. No.: US 2025/0235941 A1
(43) Pub. Date: Jul. 24, 2025

(54) Bandsaw Cutting System

(71) Applicant: Textron Aviation Inc., Wichita, KS (US)

(72) Inventor: David Gustavo Portilla, Chihuahua (MX)

(21) Appl. No.: 18/421,966

(22) Filed: Jan. 24, 2024

(51) Int. Cl. B23D 59/00; B23D 55/00

(52) U.S. Cl. CPC B23D 59/001; B23D 55/00

(57) ABSTRACT

A safety apparatus and method for a bandsaw include a saw blade actuated by a motor and a controller communicatively coupled with a camera and the motor. The camera provides a camera view that includes the saw blade and a work surface adjacent the saw blade. The controller uses a safety program to perform the steps of: assigning a reference location in the camera view; creating a computer hand model corresponding to a user's hand as seen in the camera view; tracking a position and an orientation of the user's hand with respect to the reference location by updating the computer hand model in real time; and arresting motion of the saw blade when the position of the user's hand reaches a predetermined distance relative to the reference location.

### BACKGROUND

### 1. Field

Embodiments of the invention relate generally to anti-cutting safety systems, and more specifically to bandsaw safety mechanisms.

### 2. Related Art

Bandsaws and table saws are employed in fields ranging from meat cutting to woodworking and often possess safety mechanisms to prevent injury from the moving blade. Vendors such as SawStop sell saw tables with safety features that applies a brake to the moving saw as soon as a user's skin or other conductive object contacts the saw, which completes a circuit and thus triggers a cartridge that engages the brake (https://www.sawstop.com/). Bandsaws are also available for more specialized uses, such as those sold by Guardian designed to process meat within industrial settings (https://www.guardianbandsaw.com/meat-bandsaw/). Workers in these contexts are expected to wear gloves, and Guardian's machines contain systems that distinguish the color of a worker's gloves and arrest the motion of the sawblade should workers glove come too close to the blade.

### SUMMARY

This summary is provided to introduce a selection of concepts in a simplified form that are further described below in the detailed description. This summary is not intended to identify key features or essential features of the claimed subject matter, nor is it intended to be used to limit the scope of the claimed subject matter. Other aspects and advantages of the invention will be apparent from the following detailed description of the embodiments and the accompanying drawing figures.

In an embodiment, a bandsaw includes: a saw blade powered by a motor, wherein the motor is configured with a brake; a work surface configured to provide a work region adjacent the saw blade; a video camera directed at the work surface such that a camera view monitors the work region and the saw blade; and a controller operatively coupled to the motor, the brake, and the video camera, wherein the controller includes a safety program configured to perform the steps of: identifying a position mark in the camera view; searching the camera view for a hand-resembling object; determining whether a hand-resembling object is present in the camera view; establishing a hand model when the hand-resembling object is determined to be present in the camera view; and allowing operation of the saw blade to begin once a hand model is established.

In another embodiment, a safety apparatus for a bandsaw includes a controller that is communicatively coupled with a camera and a motor controller, the safety apparatus includes: a saw blade actuated by a motor, wherein the motor is governed by the motor controller; a camera view provided via the camera, wherein the camera view includes the saw blade and a work surface adjacent the saw blade; and a safety program stored in a memory of the controller and configured to be executed by a processor of the controller, wherein the safety program is configured to perform the steps of: assigning a reference location in the camera view; creating a computer hand model corresponding to a user's hand as seen in the camera view; tracking a position and an orientation of the user's hand with respect to the reference location by updating the computer hand model in real time; and arresting motion of the saw blade when the position of the user's hand reaches a predetermined distance relative to the reference location.

In yet another embodiment, a method for preventing user injury during the operation of a bandsaw, includes: imaging the bandsaw via a camera operatively coupled to a controller; imaging a user's hand via the camera; creating, via the controller, a model of the user's hand based on images obtained via the camera; updating the model in real time as the user uses the bandsaw; monitoring a distance between the user's hand and a predefined reference location that is viewable via a camera view; detecting an unsafe condition when the distance is below a predetermined threshold; arresting motion of the bandsaw when an unsafe condition is detected; prohibiting the bandsaw from resuming operation if the unsafe condition persists; and permitting motion of the bandsaw to resume if the unsafe condition ends.

### BRIEF DESCRIPTION OF THE DRAWING FIGURES

Embodiments of the invention are described in detail below with reference to the attached drawing figures, wherein:

FIG. 1A shows an embodiment of a bandsaw cutting system with a hardware enclosure containing a computer and a camera in a close-up view showing the bandsaw work surface;

FIG. 1B demonstrates a full perspective view of the embodiment bandsaw shown in FIG. 1A;

FIG. 1C depicts a preexisting bandsaw outfitted with a camera and other components, in an embodiment;

FIG. 2 shows a diagram of the connections between electrical components in a bandsaw and a hardware enclosure, in an embodiment;

FIG. 3 shows another embodiment of a bandsaw cutting system that demonstrates the unsafe working condition and use of bandsaw components to monitor the user's hands as a user cuts a workpiece;

FIG. 4A shows an embodiment of a hand model that may be computer-generated for use in the safety features of a bandsaw cutting system, such as the embodiments shown in FIG. 1A, FIG. 1B, FIG. 1C, and FIG. 3;

FIG. 4B shows the hand model of FIG. 4A in a different orientation and position with the hand model of FIG. 4A overlaid;

FIG. 4C shows the hand model of FIG. 4A in a different orientation and position with the hand model of FIG. 4A overlaid;

FIG. 5 shows a process for the startup routine of a computerized safety program in a bandsaw cutting system; and

FIG. 6 shows a process for safe operation of a bandsaw cutting system with a computerized safety program and camera.

The drawing figures do not limit the invention to the specific embodiments disclosed and described herein. The drawings are not necessarily to scale, emphasis instead being placed upon clearly illustrating the principles of the invention.

### DETAILED DESCRIPTION

The following detailed description references the accompanying drawings that illustrate specific embodiments in which the invention can be practiced. The embodiments are intended to describe aspects of the invention in sufficient detail to enable those skilled in the art to practice the invention. Other embodiments can be utilized, and changes can be made without departing from the scope of the invention. The following detailed description is, therefore, not to be taken in a limiting sense. The scope of the invention is defined only by the appended claims, along with the full scope of the equivalents to which such claims are entitled.

In this description, references to “one embodiment,” “an embodiment,” or “embodiments” mean that the feature or features being referred to are included in at least one embodiment of the technology. Separate references to “one embodiment,” “an embodiment,” or “embodiments” in this description do not necessarily refer to the same embodiment and are also not mutually exclusive unless so stated and/or except as will be readily apparent to those skilled in the art from the description. For example, a feature, structure, act, etc. described in one embodiment may also be included in other embodiments, but is not necessarily included. Thus, the technology can include a variety of combinations and/or integrations of the embodiments described herein.

Bandsaws may both expedite and endanger any manufacturing process. By providing an open work surface around a high-power saw blade, they allow users to freely saw workpieces in varied positions and orientations. However, the use of a high-powered saw presents a risk to users due to certain work pieces requiring them to bring their hands close to the blade, risking a possible laceration, amputation, or other injury should a user touch the blade. To circumvent this, bandsaws may incorporate safety mechanisms to minimize or prevent injury if a user's hand contacts or approaches the blade.

Bandsaws with a metal blade may configure the blade to be part of an open circuit. In these systems, when a user touches the blade, the circuit is completed, triggering a cartridge to release a steel brake against the saw to arrest the motion of the saw in under a second. However, when sawing an electrically conductive material such as metal, this system is no longer effective because the workpiece will complete the circuit on contact with the blade.

Other systems have used cameras to monitor the bandsaw workspace with some method of recognizing the user in the camera feed. In these systems, software recognizes where a user's hands are typically positioned when working with a work piece on the bandsaw. These systems, however, are inefficient when workers use different hand positionings, as might happen when workers work on different workpieces using the same bandsaw, or when two workers simply prefer to hold the same piece in a different way. Thus, what is required is a bandsaw that allows users the freedom to orient and saw a metal workpiece as they wish without compromising user safety or bandsaw efficiency. Described below are embodiments of a bandsaw setup that comprises a camera and computer software that conjunctly operate to recognize a user's hands in a variety of orientations, monitor the position of the user's hands, and take protective measures by stopping the saw blade should contact between the user's hands and the saw appear imminent.

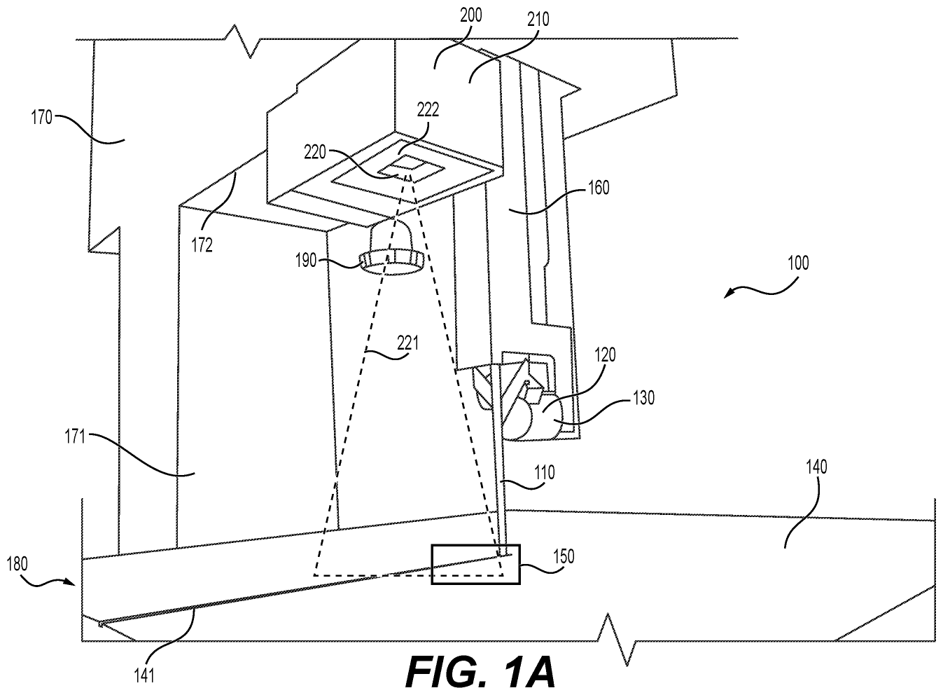

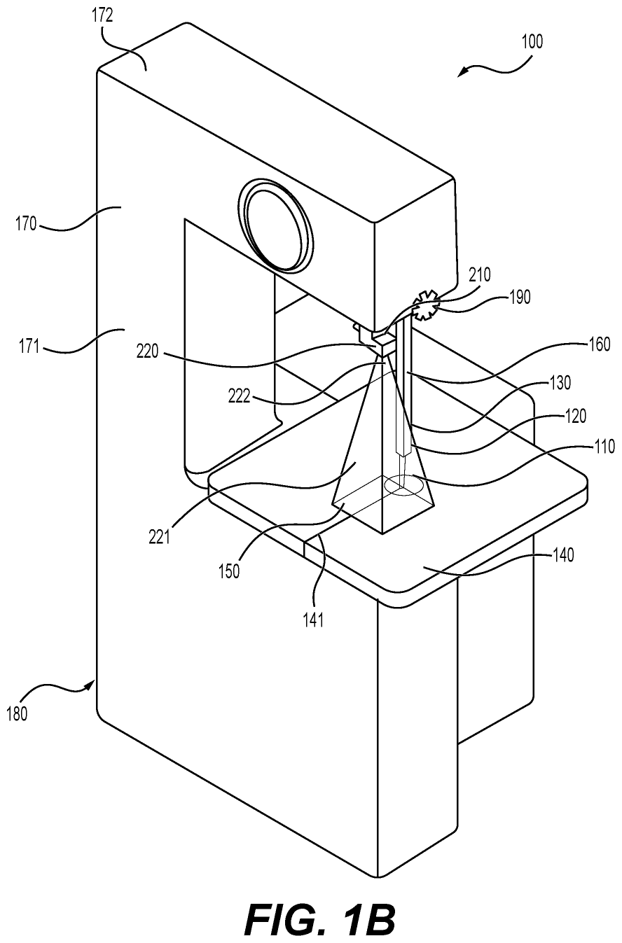

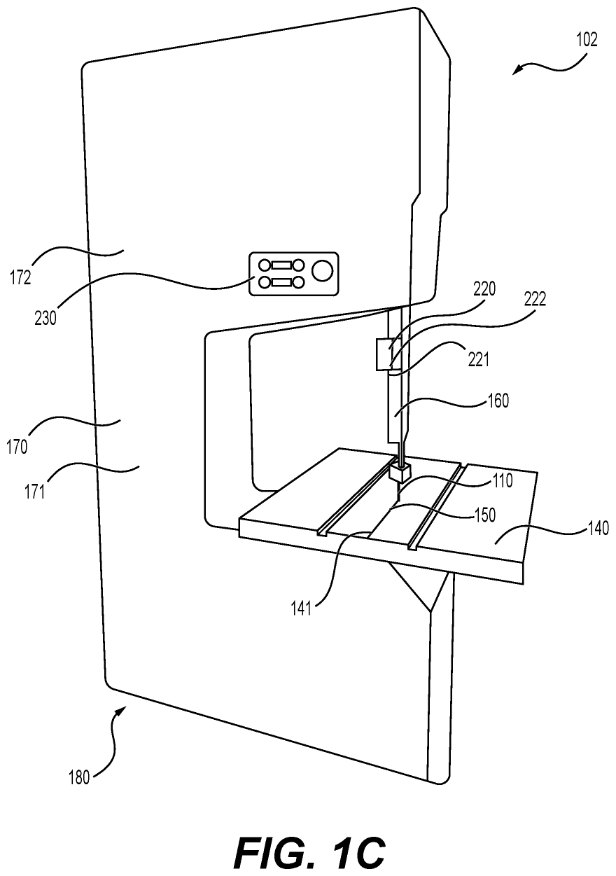

FIG. 1A shows a bandsaw 100 with saw blade 110, motor 120, electromagnetic brake 130, work surface 140, work region 150, extension 160, arm 170, base 180, and adjustment gear 190. Adjustment gear 190 may be used to secure components in place relative to work surface 140, and may be rotated to move components, such as by rotating adjustment gear 190 on bandsaw 100 to raise or lower the height of camera 220. Multiple adjustment gears 190 may be disposed on bandsaw 100 to reposition components relative to work surface 140. This embodiment demonstrates a vertical saw setup wherein sawblade 110, motor 120, and electromagnetic brake 130 are held in place above work surface 140 by being mounted, attached, or otherwise disposed on extension 160, but in other embodiments, a circular buzz saw mounted on base 180 and disposed in a hole in work surface 140 may be fitted on bandsaw 100. Other cutting equipment such as a laser may also comprise bandsaw 100 and be attached to base 180, work surface 140, extension 160, arm 170, or another feature of bandsaw 100 such that a user may conveniently use bandsaw 100 to cut a workpiece. Similarly, a different setup or alternate positioning for motor 120 and electromagnetic brake 130 could be used with saw blade 110 or a different type of cutting equipment, and a brake other than an electromagnetic brake may also be suitable in other embodiments.

Saw blade 110 is a metal blade oriented perpendicular to the plane of the work surface. When sawblade 110 is in motion, a user may press a workpiece against sawblade 110 to cut the work piece. Motor 120 may be an electric motor or another type of motor. Motor 120 is mechanically linked to sawblade 110 such that motor 120 governs the speed of sawblade 110. Electromagnetic brake 130 arrests the motion of sawblade 110 when electromagnetic brake 130 is engaged. Electromagnetic brake 130 may be a part of motor 120. Work surface 140 comprises a flat metal surface on top of base 180 upon which a workpiece may be laid during operation of bandsaw 100. Work surface 140 comprises insert 141, which presents a line of reference for a user cutting a workpiece on bandsaw 100. In other embodiments, work surface 140 may comprise an alternate material, such as wood. Extension 160 comprises a metal support protruding downward from arm 170. Arm 170 comprises a metal support with a vertical segment 171 and a horizontal segment 172. Horizontal segment 172 is disposed on base 180 of bandsaw 100. Vertical segment 171 is disposed at a sufficient height such that a user is allowed freedom of motion when operating bandsaw 100. Similarly, horizontal segment 172 is positioned away from work region 150 such that a user is allowed freedom of motion when operating bandsaw 100. Base 180 of bandsaw 100 is a metal support structure upon which components of bandsaw 100 may be mounted via screws, welding, glue, or other attachment means. Base 180 provides a point of contact between the floor and bandsaw 100 such that base 180 holds bandsaw 100 stable when in use. To use bandsaw 100, an operator may bring a workpiece into work region 150 while motor 120 is operating to cut the work piece against saw blade 110. Work region 150 is an area near saw blade 110 and work surface 140 where a user may manipulate a workpiece with their hands.

In an embodiment, bandsaw 100 comprises hardware enclosure 200, which comprises at least controller 210 and camera 220. Hardware enclosure 200 comprises a metal box that houses controller 210, camera 220, and other components such as a power supply, cooling fan, programmable logic controller (PLC), relay module, or other electrical components. Controller 210 may be a single board computer (SBC), programmable logic controller (PLC), a combination thereof, or a plurality of computers with installed programs such as a safety program or general bandsaw operation routines. Camera 220 is a video camera in a fixed position above work surface 140. Camera 220 records live video feed in camera view 221. Camera 220 may have an integrated light, such as LED 222, which illuminates work surface 140 and work region 150. In other embodiments, camera 220 may have no light, or may have a light source other than an LED, such as an incandescent bulb. Camera view 221 includes work region 150 and saw blade 110. In other embodiments, camera view 221 may be more expansive and be disposed to view more parts of bandsaw 100. In bandsaw 100, hardware enclosure 200 is integrated into bandsaw 100, but other embodiments may have a detached or replaceable camera, or a camera may monitor work region 150 from a different position relative to work region 150.

FIG. 1B provides a full view of bandsaw 100. An additional adjustment gear 190 is visible to adjust the height of arm 160, and by extension saw blade 110. In embodiments, base 180 may contain all or parts of motor 120 and electromagnetic brake 130. Computer 210 may also be stored in base 180 in lieu of hardware enclosure 200.

FIG. 1C demonstrates an embodiment bandsaw 102. Bandsaw 102 consists of a camera 220 fitted onto an existing bandsaw. Note that in this embodiment, computer 210, motor 120, and electromagnetic brake 130 are not shown as they are disposed differently on bandsaw 102 compared to their positions on bandsaw 100. Thus, hardware enclosure 200 is not used. In embodiments of bandsaw 100 and 102, computer 210, motor 120, electromagnetic brake 130, and other components may be disposed within base 180, arm 170, or on the exterior of the bandsaw. To create bandsaw 102, an existing bandsaw would be provided, and the bandsaw would be modified with computer 210 and camera 220. Software including a safety program installed on computer 210 would be included with bandsaw 102 as with bandsaw 100. The purpose, function, and execution of a safety program are discussed in detail later.

In an embodiment, camera 220 does not require light 222. Camera 220 may contain onboard software to automatically adjust to ambient light levels, or lighting around bandsaw 100 is sufficient to illuminate the view of camera 220 for effective operation of the safety features of bandsaw 100. A control panel 230 is visible on bandsaw 102. Control panel 230 is disposed in an inset of arm 170 of bandsaw 102, but in other embodiments may be disposed on base 180, attached by wire, or other positioned and connected to a bandsaw. Control panel 230 may be used to adjust the speed of the bandsaw, turn the bandsaw on or off, or toggle other features of the bandsaw. A user may operate control panel 230 using any number of buttons, switches, touch screens, or other input features.

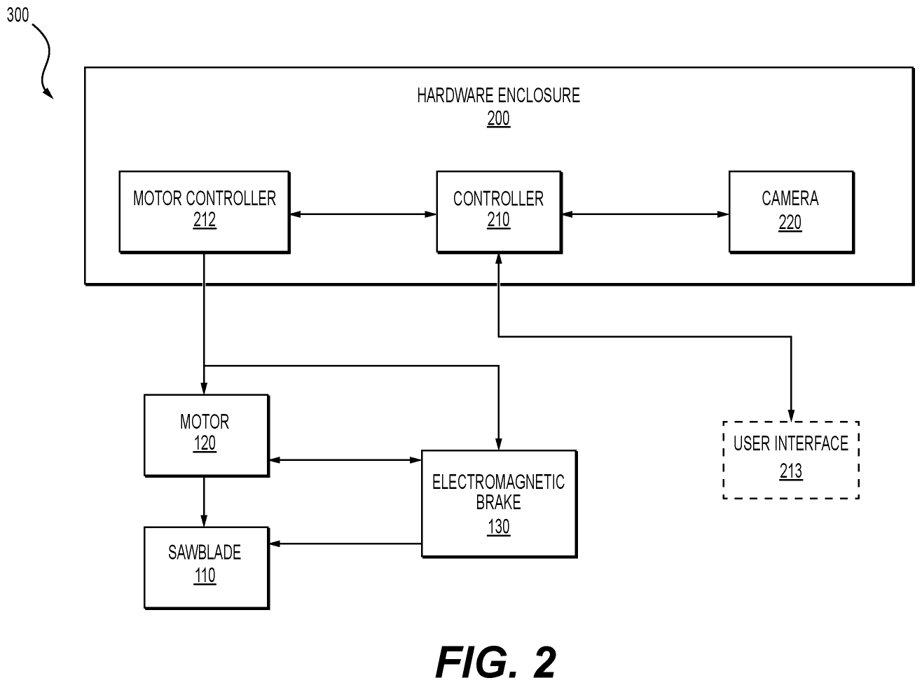

FIG. 2 is a block diagram showing components of an exemplary control system 300 for controlling saw blade 110 and monitoring and enforcing user safety on bandsaw 100. Within FIG. 2, a one-way arrow implies that one component governs the other, while a two-way arrow implies that two components transmit signals between one another. Control system 300 comprises hardware enclosure 200, controller 210, camera 220, motor controller 212, motor 120, electromagnetic brake 130, saw blade 110, and may comprise a user interface 213. Within control system 300, components may be electrically interfaced between one another. Other components, such as motor 120 and saw blade 110, or saw blade 110 and electromagnetic brake 130, may be mechanically linked to one another. Within hardware enclosure 200, controller 210 is electrically interfaced to camera 220 and motor controller 212. Controller 210 may comprise a computer, which may be a single board computer (SBC) with a relay module. Within controller 210 may be a processor, computer memory, and data storage means, such as a solid-state drive, or other components such as may allow controller 210 to store and execute software. The computer comprising controller 210 may comprise these components. Controller 210 may also comprise a programmable logic controller (PLC) interfaced to camera 220 or motor controller 212. A computer and a programmable logic controller may function in tandem to perform desired operations of control system 300. In other embodiments, controller 210 may be separate from hardware enclosure 200 or bandsaw 100 entirely, and may comprise a plurality of different computer units, such as more than one single board computer and one programmable logic controller.

Controller 210 is electrically interfaced (bussed) to camera 220 and motor controller 212, and as such these components may send and receive electrical signals to transmit data between one another. Controller 210 may be outfitted with a power supply that powers controller 210 and camera 220. Because motor controller 212 is bussed to motor 120 and electromagnetic brake 130, controller 210 may control the speed of motor 120 through electrical signals sent to motor controller 212. An example of this would be an electrical signal sent by controller 210 to motor controller 212 to engage electromagnetic brake 130, which is electrically interfaced, mechanically linked, or otherwise integrated into motor 120. Thus, given that saw blade 110 is mechanically linked to motor 120 and/or electromagnetic brake 130, controller 210 may have authority over saw blade 110, motor 120, electromagnetic brake 130, or other components of bandsaw 100. Additionally, user interface 213 may allow an operator of bandsaw 100 to directly interact with the software installed on controller 210. User interface 213 may comprise a keyboard, mouse, monitor, touchscreen, or other typical I/O components. An example interaction may be to set the speed of sawblade 100.

A safety program may be stored in computer memory of controller 210. This safety program comprises software that monitors work region 150 using video feed from camera 220. By sending electrical signals to motor controller 212 from controller 210, execution of this safety program may engage electromagnetic brake 130 or stop motor 120 if an unsafe working condition is detected in work region 150.

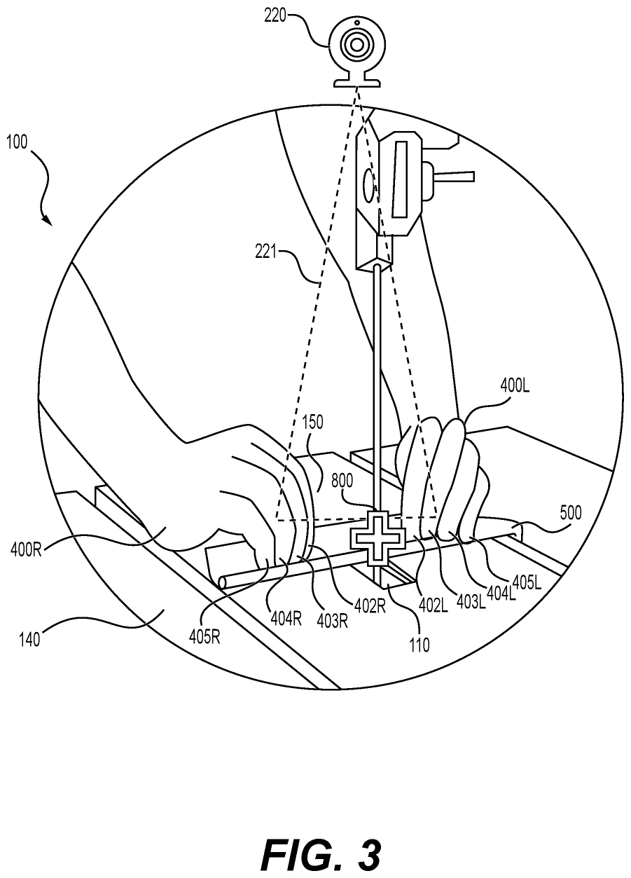

FIG. 3 demonstrates a bandsaw 100 with a user disposing their hands 400L and 400R to handle workpiece 500 near sawblade 110. Camera 220 views workspace 150 in camera view 221, and a mark 800 is present in camera view 221. Mark 800 is a defined point in camera view 221. For instance, mark 800 may be a cartesian coordinate or other quantified datum stored in camera 220 or controller 210. Present in workspace 150 are workpiece 500, saw blade 110, and the user's hands 400L and 400R. In an embodiment, a safety program with access to data from camera 220 may identify the hands 400L and 400R of the user by the distinctive shape of the fingers and thumbs (hereinafter ‘digits’) of hands 400L and 400R, such as with a model of the digits 401L (hidden from view), 402L, 403L, 404L, 405L, 401R (hidden from view), 402R, 403R, 404R, and 405R in camera view 221. This safety program may identify other distinctive features of hands 400L and 400R in other embodiments, such as the knuckles or wrists. In camera view 221, the digits 401L-405R distinguish hands 400L and 400R from work surface 140, saw blade 110, workpiece 500, or other features apparent in camera view 221. The user handles workpiece 500 with both hands 400L and 400R; however, other shapes of workpiece 500 may require the user to position and orient their hands 400L and 400R differently to effectively make a desired cut on workpiece 500 using bandsaw 100. As such, the user's hands may appear differently in camera view 221, for example without their knuckles visible to camera 220, or with their thumbs fully visible.

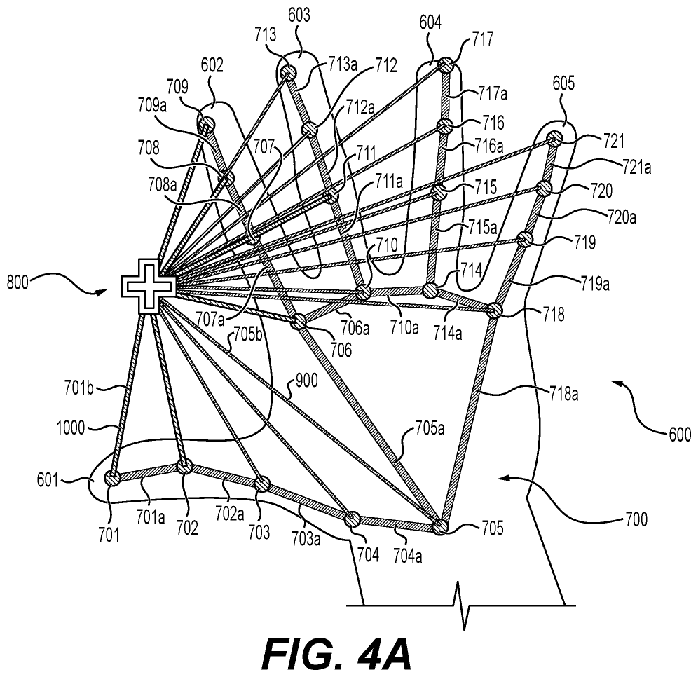

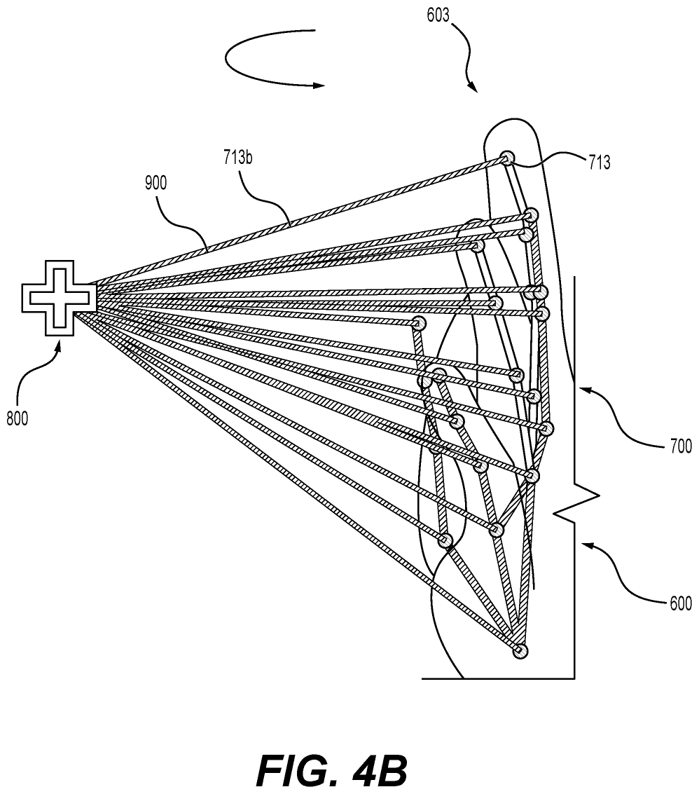

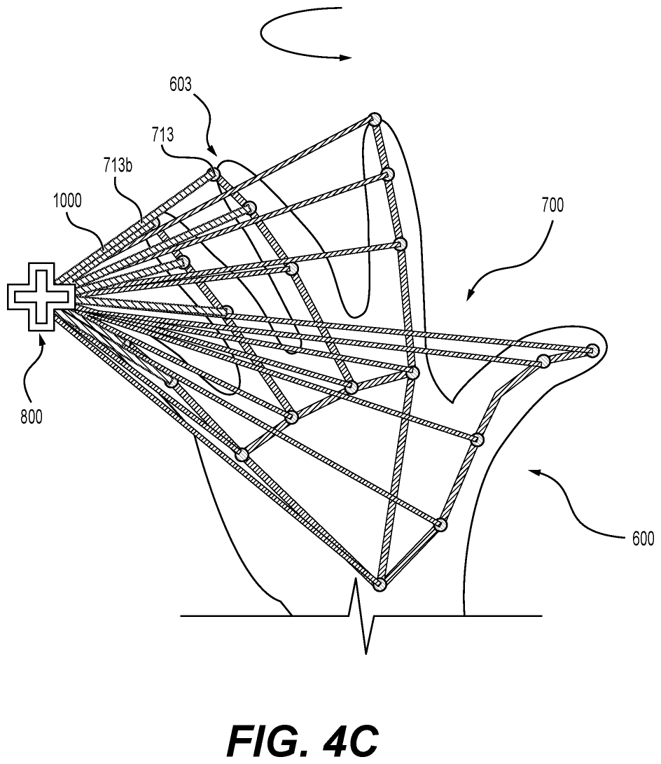

FIG. 4A shows a user's hand 600 with an overlaid AI-generated hand model 700, along with mark 800. A safety program installed in controller 210 may use the video feed from camera 220 to create hand model 700. As demonstrated in FIG. 2, this safety program and camera 220 are interfaced via bus and able to transmit electrical signals to one another. This safety program may comprise an algorithm, machine learning program, or artificial intelligence (AI) program that processes image data from camera 220 to create and thereafter track the position and orientation of hand 600 by repositioning and rearticulating hand model 700. This safety program may be used to create any number of hand models 700 from a user's hand or hands, such as hands 400L and 400R in FIG. 3.

In an embodiment, hand model 700 comprises landmarks 701 to 721 such that landmarks 701 to 721 model the shape of a user's hand. Landmarks 701 to 721 represent a user's hand with twenty-one landmarks mapped to the digits 601, 602, 603, 604, and 605 of the user's hand. In an embodiment, each landmark is a vertex that comprise a geometric model of the hand wherein the vertices are connected to create the shape of fingers, a thumb, and a wrist. Digit 601 is represented by landmarks 701, 702, 703, 704, and 705, which represent the user's thumb. Digit 602 is represented by landmarks 706, 707, 708, and 709, which represent the user's index finger. Digit 603 is represented by landmarks 710, 711, 712, and 713, which represent the user's middle finger. Digit 604 is represented by landmarks 714, 715, 716, and 717, which represent the user's ring finger. Digit 605 is represented by landmarks 718, 719, 720, and 721, which represent the user's pinky finger. Alternate embodiments may place any number of landmarks at any point on a user's hand 600 to create a hand model 700; other distinct hand features such as the palm, wrist, or knuckles may be tracked to create hand model 700 in other embodiments.

In hand model 700, landmarks 701 to 721 are connected to each other via connections 701a to 721a. In an embodiment, the lines drawn by connections 701a to 721a represent the user's digits or other features representative of the shape of a user's hand. An embodiment arrangement of these connections is as follows: connections 701a, 702a, 703a, and 704a model the thumb on the user's hand. Connections 705a, 707a, 708a, and 709a model the index finger and part of the palm on the user's hand. Connections 711a, 712a, and 713a model the middle finger on the user's hand. Connections 714a, 715a, and 716a model the ring finger on the user's hand. Connections 718a, 719a, 720a, and 721a model the pinky finger and part of the palm on the user's hand. Connections 706a, 710a. and 714a model part of the palm on the user's hand.

Additionally, each of the landmarks 701 to 721 has a distance vector 701b through 721b drawn to mark 800. Using a video feed captured by camera 220, the safety program may also compute a plurality of trajectory vectors 701c through 721c for landmarks 701 through 721 wherein trajectory vectors 701c through 721c describe the expected movement of landmarks 701 through 721 in future frames of the video feed recorded by camera 220.

Information about each of landmarks 701 to 721 is stored within an array, list, or data structure, and data for all landmarks 701 to 721 are stored together in a matrix. A safety program installed on computer 210 of an embodiment bandsaw may create, access, and update this data. In an embodiment, landmark tracking is accomplished by assigning each of landmarks 701 to 721 a numerical value in four data fields: a hand ID, a landmark ID, an x-position, and a-y position. These data are stored in a list by the safety program. Together, these data distinguish each landmark. The hand ID is used to identify the hand that a given landmark is a part of. For instance, a user's left hand may be assigned hand ID “1”, and the user's right hand may be given a hand ID “2”. The landmark ID identifies a specific landmark within a hand. For instance, given 21 landmarks per hand, each landmark would be given an integer identifier 0 through 20 or 1 to 21 to distinguish the landmarks on a particular hand. The x-position and y-position provide the positions of each landmark within view of the camera. The x-position and y-position of a landmark are used to calculate a distance from that landmark to mark 800. Mark 800 is a point in camera view 221 of camera 220. In an embodiment, a user determines the position of mark 800 as seen in camera view 221 of camera 220. For instance, controller 210 may be interfaced to a set of I/O controls available to a user, such as a mouse, keyboard, or monitor, or user interface 213 as introduced in FIG. 2. Using user interface 213, a user may be able to assign mark 800 to the location of the sawblade 110 on a bandsaw 100 as seen in camera view 221 of camera 220, thereby marking a point at which a user may be injured by sawblade 110 during the operation of band saw 100.

Hand model 700 is demonstrated in an alternate position and orientation in FIG. 4B. A sample landmark 713 with distance vector 713b is identified on digit 603 to clarify how safety program 613 tracks and adjusts hand model 700 as the position and orientation of hand 600 changes. As a user moves their hand 600 in view of camera 220, the safety program may track hand 600 and continuously superimpose hand model 700 over hand 600. Thus, the safety program dynamically tracks hand 600 as hand 600 assumes a variety of positions and orientations while in view of camera 220. Thus, the positions of landmarks 701 through 721 move such that they remain superimposed on hand 600 as hand 600 moves.

FIG. 4C demonstrates another position and orientation of hand 600 with hand model 700 superimposed over hand 600. To demonstrate the dynamic tracking, note that distance vector 713b shown in FIG. 4B is denoted a safe distance 900 away from mark 800 while the same distance vector 713b shown in FIG. 4C is denoted an unsafe distance 1000 away from mark 800. The safety program monitors the distance vectors 701b to 721b and the trajectory vectors 701c to 721c while a user operates bandsaw 100. The safety program may have access to a numerical value or values of safe distances for any landmarks 701 to 721 to be at relative to mark 800 and will compare these values to the values of distance vectors 701b through 721b. The safety program may represent vectors 701b through 721b as a safe distance 900 or a dangerous distance 1000. As the safety program monitors trajectory vectors 701c through 721c of landmarks 701 to 721, it may determine that any landmark 701 to 721 may be about to reach an unsafe distance 1000 relative to mark 800, or that a landmark 701 to 721 remains and/or will remain a safe distance from mark 800.

Unsafe distance 1000 is a radius or line segment with one vertex on mark 800. Unsafe distance 1000 may be arbitrarily assigned, assigned by a user, or calculated by the safety program. The safety program may use a known brake response time, an added ‘safety window’ of time, and a top speed of a user's hands (pre-assigned or otherwise determined) to compute unsafe distance 1000. The safety program may measure unsafe distance 1000, connections 701a to 721a, distance vectors 701b to 721b, and trajectory vectors 701c to 721c in units of pixels to streamline the usage of video feed of camera 220. A safe distance 900 may be considered any distance greater than unsafe distance 1000.

In the event that the safety program detects an unsafe distance from any distance vector 701b to 721b, or detects an unsafe trajectory using any trajectory vector 701c to 721c, the safety program may engage electromagnetic brake 130 to stop the operation of saw blade 110 with the transmission of one or a plurality of electrical signals from controller 210 to motor controller 212. Thus, the safety program prevents the user from injuring themselves by contacting hand 600 with an active sawblade 110. The safety program may engage electromagnetic brake 130, stop motor 120, or otherwise override the functions of bandsaw 100 when an unsafe condition such as an unsafe distance 1000 is detected.

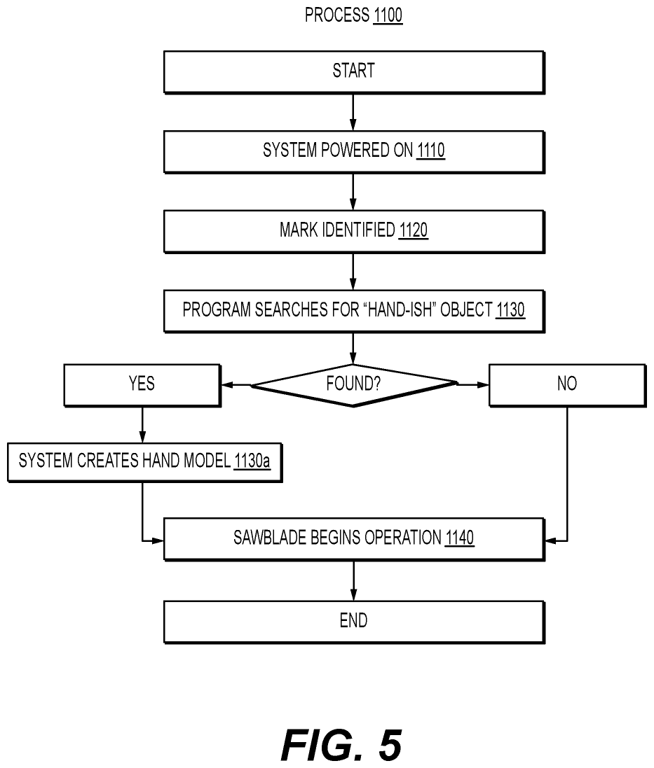

FIG. 5 shows a process 1100 wherein a bandsaw with controller 210, an installed safety program, and camera 220 is powered on. In step 1110, the system is powered on. In step 1120, controller 210 is assigned a mark 800 in camera view 221 of camera 220. Mark 800 in camera view 221 of camera 220 may be manually assigned by the bandsaw user, be automatically identified by controller 210, or otherwise be assigned. In step 1130, the safety program will then process the video feed from camera 220 to locate an object in the scene. The object may resemble a user's hand, such as hand 600 shown in FIG. 3. Optionally, a user may be expected or prompted to display their hands in camera view 221 at this step. In an embodiment, if a user's hand 600 is found in view of camera 220, the safety program will establish a hand model in step 1130a. This hand model may be hand model 700 with landmarks 701 to 721 and landmark connections 701a to 721a as shown in FIG. 3. However, if the safety program is unable to identify a user's hand in this instance, it will not create a hand model 700, and the safety program may allow the bandsaw to run without tracking a user's hands, thereby effectively disabling the safety features of bandsaw 100.210. In step 1140, the bandsaw begins operation, such as by moving saw blade 110 by powering motor 120.

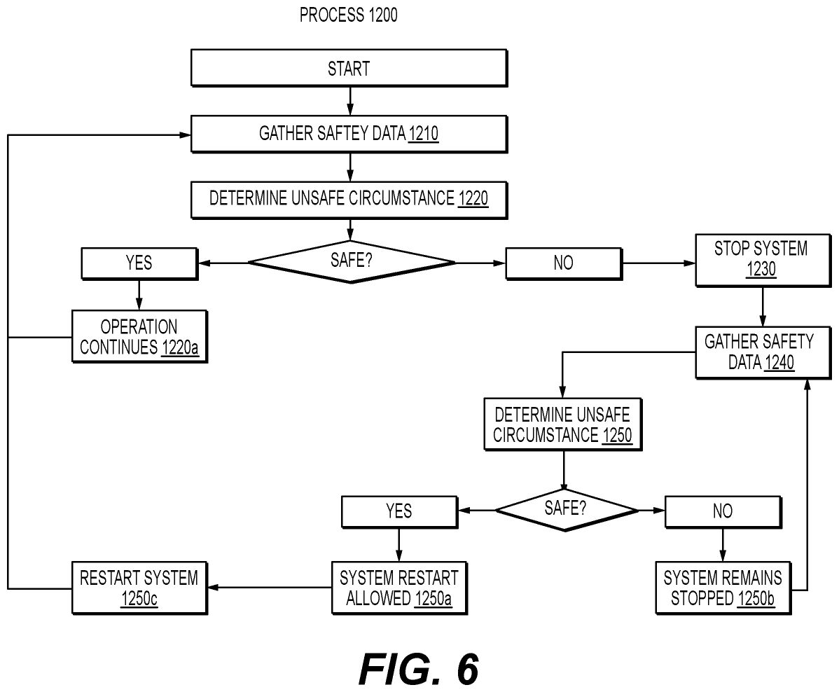

Process 1200, as shown in FIG. 6, demonstrates the continuous operating procedure of a safety program as a user performs work using bandsaw 100. Using hand model 700 as created upon bandsaw 100 startup in process 1100, the safety program continuously monitors the position of a user's hands by overlaying hand model 700 onto the user's hand. Note that a single hand, two hands, or a plurality of hands may be monitored by the safety program. In such an instance, the safety program will create a hand model for each hand it identifies in the feed of camera 220. In step 1210, the safety program tracks the position and orientation of hand model 700 and gathers safety data from camera 220. In embodiments, this safety data may include the hand ID, landmark ID, x-position, and y-position of each landmark. More safety data such as distance vectors 701b to 721b or trajectory vectors 701c to 721c may be computed in this step by the safety program using mark 800, the x-position and y-position of each landmark, and other data available to the safety program.

In step 1220, the safety program uses the safety data from hand model 700 and camera 220 to determine if an operator is in unsafe circumstances or will be in unsafe circumstances. For instance, the safety program may identify a distance vector 701b to 721b of a landmark of hand model 700 as being too close to mark 800 such that one of the distance vectors 701b to 721b has reached an unsafe distance 1000. In this case, unsafe distance 1000 serves as a threshold. For instance, when the value of a distance vector 701b to 721b is less than unsafe distance 1000, the safety program may determine that the circumstance is unsafe. The safety program may also calculate a future unsafe distance to mark 800 using a trajectory vector 701c to 721c of a given landmark in hand model 700. In an embodiment, a radius is assigned as a safe distance away from mark 800. If the landmark falls within this radius, an unsafe circumstance occurs. If the circumstance is determined to be safe, the process continues to step 1220a, in which the bandsaw continues to operate, and the safety program returns to step 1210 automatically, thus making bandsaw operation continuous. If the circumstance is determined to be unsafe, such as when a distance vector 701b to 721b falls below the threshold given by unsafe distance 1000, the safety program moves to step 1230. In step 1230, the bandsaw system is stopped. This may constitute engaging electromagnetic brake 130, stopping motor 120, or engaging other mechanisms that arrest the motion of sawblade 110. As demonstrated in FIG. 2, motor 120 and controller 210 are connected via buses such that controller 210 may govern motor 120 and electromagnetic brake 130 through the transmission of electrical signals. In step 1240, the safety program tracks the position and orientation of hand model 700 and gathers safety data from camera 220, as in step 1210. However, in step 1250, motion of the saw is stopped. In step 1250, the safety program performs another check to see if the unsafe circumstance persists. If the circumstance is determined to be safe, the process continues to step 1250a, in which the bandsaw may be restarted. In alternate embodiments, the saw may automatically restart at step 1250a, which may comprise moving to step 1250c to restart the system, then returning to step 1210, from where bandsaw 100 operation remains continuous. If the circumstance is determined to be unsafe, the safety program moves to step 1250b, and the system is not allowed to restart. The system may return to step 1240 every time it reaches step 1250b, and the system will thus continuously check for a safe or unsafe circumstance. In the event that the circumstance becomes safe, such as with the value of every distance vector 701b to 721b of hand model 700 being above the threshold of unsafe distance 1000, the system may restart by reaching step 1250a, and bandsaw operation may resume.

In an embodiment, the safety program monitors the position of a user's hands through a four-step process. The first steps are: video acquisition, landmark positioning, landmark tracking, and danger zone monitoring. In the video acquisition step, the safety program receives video free from camera 220. In the landmark positioning step, the safety program assigns the position of each landmark to any “hand-ish” (i.e., hand-resembling) objects identified in the video feed. In the landmark tracking step, the safety program calculates the distance of each landmark from mark 800. In the danger zone monitoring step, the safety program determines if the distances calculated in the landmark tracking step are within an unsafe distance 1000 of mark 800. If a given landmark is determined to be within an unsafe distance 1000, the safety program will then engage electromagnetic break 130 or other means to stop the operation of the sawblade. The video acquisition step, landmark positioning step, and landmark tracking step occur within step 1210 of process 1200 and are a specific (but not limiting) embodiment of how step 1210 may be performed. The danger zone monitoring step occurs within step 1220 of the process but does not describe the only way in which step 1220 may be performed.

Generally, embodiments disclosed herein may be useful for any bandsaw safety system. Similar benefits on high power cutting systems, such as table saws, may be achieved with an alternate configuration of the bandsaw safety system components and processes disclosed herein.

Although the invention has been described with reference to the embodiments illustrated in the attached drawing figures, it is noted that equivalents may be employed and substitutions made herein without departing from the scope of the invention as recited in the claims.

Having thus described various embodiments of the invention, what is claimed as new and desired to be protected by Letters Patent includes the following:

1. A bandsaw, comprising:
a saw blade powered by a motor, wherein the motor is configured with a brake;
a work surface configured to provide a work region adjacent the saw blade;
a video camera directed at the work surface such that a camera view monitors the work region and the saw blade; and
a controller operatively coupled to the motor, the brake, and the video camera, wherein the controller comprises a safety program configured to perform the steps of:
identifying a position mark in the camera view;
searching the camera view for a hand-resembling object;
determining whether a hand-resembling object is present in the camera view;
establishing a hand model when the hand-resembling object is determined to be present in the camera view; and
allowing operation of the saw blade to begin once a hand model is established.

2. The bandsaw of claim 1, wherein the saw blade is disposed vertically via an arm.

3. The bandsaw of claim 1, wherein a hardware enclosure is disposed above the work surface, the hardware enclosure being configured to house the camera.

4. The bandsaw of claim 1, comprising an LED light configured to illuminate the work surface.

5. The bandsaw of claim 1, wherein the safety program monitors the position of a user's hand based on the hand model, wherein the hand model comprises a computer model of the user's hand.

6. The bandsaw of claim 1, wherein the motor is configured with an electromagnetic brake.

7. The bandsaw of claim 6, wherein the motor may receive an electrical signal that triggers the electromagnetic brake thereby arresting motion of the saw blade, wherein the signal is based on a distance determined by the controller of the position mark from the hand model.

8. A safety apparatus for a bandsaw comprising a controller that is communicatively coupled with a camera and a motor controller, the safety apparatus comprising:
a saw blade actuated by a motor, wherein the motor is governed by the motor controller;
a camera view provided via the camera, wherein the camera view comprises the saw blade and a work surface adjacent the saw blade; and
a safety program stored in a memory of the controller and configured to be executed by a processor of the controller, wherein the safety program is configured to perform the steps of:
assigning a reference location in the camera view;
creating a computer hand model corresponding to a user's hand as seen in the camera view;
tracking a position and an orientation of the user's hand with respect to the reference location by updating the computer hand model in real time; and
arresting motion of the saw blade when the position of the user's hand reaches a predetermined distance relative to the reference location.

9. The safety apparatus of claim 8, wherein the safety program models the user's hand as a set of connected landmarks.

10. The safety apparatus of claim 9, wherein tracking the position and the orientation of the user's hand comprises superimposing the computer hand model over a real-time image of the user's hand.

11. The safety apparatus of claim 9, wherein tracking the position and the orientation of the user's hand comprises tracking distances of the landmarks relative to the reference location in the camera view.

12. The safety apparatus of claim 9, comprising determining trajectories of the landmarks.

13. The safety apparatus of claim 8, comprising simultaneously tracking both hands of a user.

14. The safety apparatus of claim 8, comprising a user interface operatively coupled with the controller, wherein the reference location in the camera view is assigned by a user upon startup of the bandsaw.

15. A method for preventing user injury during the operation of a bandsaw, comprising:
imaging the bandsaw via a camera operatively coupled to a controller;
imaging a user's hand via the camera;
creating, via the controller, a model of the user's hand based on images obtained via the camera;
updating the model in real time as the user uses the bandsaw;
monitoring a distance between the user's hand and a predefined reference location that is viewable via a camera view;
detecting an unsafe condition when the distance is below a predetermined threshold;
arresting motion of the bandsaw when an unsafe condition is detected;
prohibiting the bandsaw from resuming operation if the unsafe condition persists; and
permitting motion of the bandsaw to resume if the unsafe condition ends.

16. The method of claim 15, wherein arresting motion of the bandsaw comprises activating an electromagnetic brake configured to stop a motor of the bandsaw.

17. The method of claim 15, wherein creating the model of the user's hand comprises superimposing landmarks over digits of the user's hand.

18. The method of claim 15 comprising forecasting an unsafe condition by determining distance vectors and trajectory vectors.

19. The method of claim 15 comprising determining the predetermined threshold distance based on an amount of time needed to arrest motion of the bandsaw.

20. The method of claim 15 comprising automatically restarting the bandsaw when the unsafe condition is no longer detected.
